(19) United States
(12) Patent Application Publication
(10) Pub. No.: US 2005/0057848 A1
(43) Pub. Date: Mar. 17, 2005

(54) Magnetic disk space

(75) Inventors: Kazutaka Okasaka, Kanagawa (JP); Hiroki Kitahori, Kanagawa (JP); Taichi Nakamura, Kanagawa (JP); Keishi Takahashi, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Netherlands, B.V., AZ Amsterdam (NL)

(21) Appl. No.: 10/889,827

(22) Filed: Jul. 12, 2004

(30) Foreign Application Priority Data
Sep. 12, 2003 (JP) 2003-320749

(51) Int. Cl. G11B 17/00

(52) U.S. Cl. 360/97.01

(57) ABSTRACT

A portable, small magnetic disk drive to be mounted on a portable device operates silently at low power consumption. In one embodiment, a spindle motor is fixed to the bottom wall of a metal base plate formed in the shape of a box by press working. The spindle motor is provided with a fluid dynamic bearing (FDB). A spindle hub is supported on the FDB, and a small magnetic disk having a diameter of about 1.8 in. (45.7 mm) or below is mounted on the spindle hub and is fastened to the spindle hub with a top clamp. The rotating speed of the spindle motor is about 4200 rpm or below. Gram load for pressing a magnetic head toward the magnetic disk is about 0.5 gf or above and less than about 1.0 gf.

### BACKGROUND OF THE INVENTION

The present invention relates to small magnetic disk drives, and more particularly, to a small magnetic disk drive provided with a spindle motor having a shaft supported by a fluid dynamic bearing (FDB), and capable of silently operating at low power consumption.

Various types of portable recording media are provided for various devices including personal computers (PC) and digital cameras to store data. Efforts have been made in recent years to provide recording media having a small size and a large storage capacity. For example, a small, portable magnetic disk drive has been proposed. This proposed disk drive has a new assembly construction based on the Compact Flash® commercially available from SanDisk Corporation, i.e., one of standards for small memory cards.

A large-capacity miniature magnetic disk drive conforming to the standard of Compact Flash Type 2 is provided with a 1 in. diameter magnetic disk having a storage capacity of 1 GB, and has a weight on the order of only 16 g.

A miniature magnetic disk drive disclosed in Japanese Patent Laid-open No. 2002-15553 (pp. 4-5, FIGS. 1 and 3) is 42.5 mm in length, 36 mm in width, and 5 mm in thickness. Even this miniature magnetic disk drive comprises, in addition to a magnetic disk for data storage, a spindle motor for rotating the magnetic disk, a magnetic head for writing and reading data to and from the magnetic disk, a suspension assembly suspending the magnetic head, an actuator supporting the suspension assembly to move the suspension assembly in a direction along the radius of the magnetic disk.

Silence and low power consumption are very important to a small, portable magnetic disk drive incorporated into a portable device. The above Japanese Patent reference discloses techniques for protecting a small magnetic disk drive from external shocks, but does not disclose any techniques for reducing noise and power consumption.

### BRIEF SUMMARY OF THE INVENTION

Embodiments of the present invention provide a small magnetic disk drive capable of silently operating at lower power consumption.

In accordance with an aspect of the present invention, a magnetic disk drive comprises a motor having a rotating shaft supported by a fluid dynamic bearing; a magnetic disk mounted on the rotating shaft; and a magnetic head pressed toward the magnetic disk by a loading force of about 0.5 gf or above and less than about 1.0 gf for data recording or reproducing, or for data recording and reproducing.

In some embodiments, an operating speed of the motor is about 4200 rpm or below, and a diameter of the magnetic disk is about 1 in. (25.4 mm) or below. In one embodiment, the magnetic head includes a slider of about 1.25 mm in length, about 1 mm in width, and about 0.3 mm in thickness. In another embodiment, the magnetic head includes a slider of about 0.85 mm in length, about 0.7 mm in width, and about 0.23 mm in thickness.

In accordance with another aspect of the invention, a magnetic disk drive comprises a case; a motor fixed to the case and having a rotating shaft supported by a fluid dynamic bearing; a magnetic disk mounted on the rotating shaft; a carriage turning shaft provided with a suspension assembly pivotally supported on the case; and a magnetic head attached to the suspension assembly, and pressed toward the magnetic disk by a loading force of about 0.5 gf or above and less than about 1.0 gf.

In some embodiments, an operating speed of the motor is about 4200 rpm or below, and a diameter of the magnetic disk is about 1 in. (25.4 mm) or below. In one embodiment, the magnetic head includes a slider of about 1.25 mm in length, about 1 mm in width, and about 0.3 mm in thickness. In another embodiment, the magnetic head includes a slider of about 0.85 mm in length, about 0.7 mm in width, and about 0.23 mm in thickness.

In accordance with another aspect of the invention, a magnetic disk drive comprises a base plate; a spindle motor fixed to the base plate, and provided with a spindle hub supported by a fluid dynamic bearing; a magnetic disk mounted on the spindle hub; a carriage shaft pivotally supported on the base plate and provided with a suspension assembly; and a slider attached to the suspension assembly, and pressed toward the magnetic disk by a loading force of about 0.5 gf or above and less than about 1.0 gf.

In some embodiments, an operating speed of the motor is about 4200 rpm or below, and a diameter of the magnetic disk is about 1 in. (25.4 mm) or below. In one embodiment, the slider measures about 1.25 mm in length, about 1 mm in width, and about 0.3 mm in thickness. In another embodiment, the slider measures about 0.85 mm in length, about 0.7 mm in width, and about 0.23 mm in thickness.

In accordance with another aspect of the invention, a magnetic disk drive comprises a base plate, a spindle motor fixed to the base plate, and having a spindle hub supported by a fluid dynamic bearing; a magnetic disk mounted on the spindle hub; a carriage turning shaft pivotally supported on the base plate and attached to a suspension assembly; a slider attached to the suspension assembly and pressed toward the magnetic disk by a loading force of about 0.5 gf or above and less than about 1.0 gf, and a voice coil motor fixed to the base plate to drive the suspension assembly for turning.

In some embodiments, an operating speed of the motor is about 4200 rpm or below, and a diameter of the magnetic disk is about 1 in. (25.4 mm) or below. In one embodiment, the slider measures about 1.25 mm in length, about 1 mm in width, and about 0.3 mm in thickness. In another embodiment, the slider measures about 0.85 mm in length, about 0.7 mm in width, and about 0.23 mm in thickness.

In accordance with another aspect of the invention, a magnetic disk drive comprises a base plate; a spindle motor fixed to the base plate, and having a spindle hub supported by a fluid dynamic bearing including a radial bearing and a thrust bearing; a magnetic disk mounted on the spindle hub; a carriage turning shaft pivotally supported on the base plate, and attached to a suspension assembly; and a slider attached to the suspension assembly, and pressed toward the magnetic disk by a loading force of about 0.5 gf or above and less than about 1.0 gf.

In some embodiments, an operating speed of the motor is about 4200 rpm or below, and a diameter of the magnetic disk is about 1 in. (25.4 mm) or below. In one embodiment, the slider measures about 1.25 mm in length, about 1 mm in width, and about 0.3 mm in thickness. In another embodiment, the slider measures about 0.85 mm in length, about 0.7 mm in width, and about 0.23 mm in thickness.

### BRIEF DESCRIPTION OF THE DRAWINGS

FIG. 1 is a perspective view of a small magnetic disk drive in a specific embodiment of the present invention.

FIG. 2 is a sectional view of a spindle motor included in the small magnetic disk drive in the specific embodiment of the present invention.

### DETAILED DESCRIPTION OF THE INVENTION

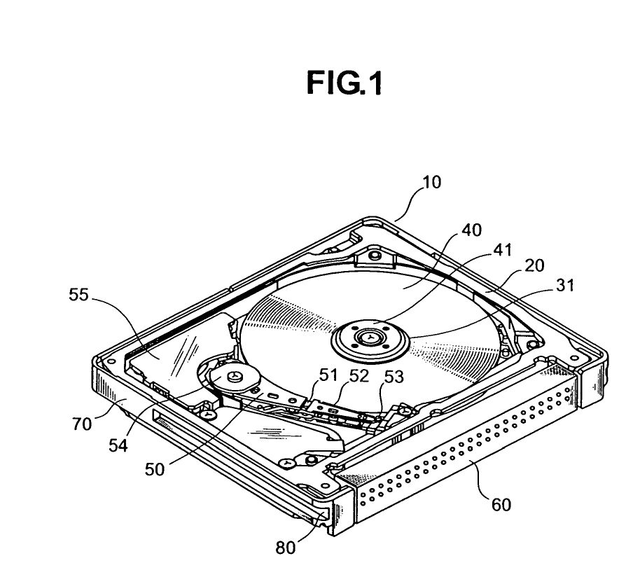

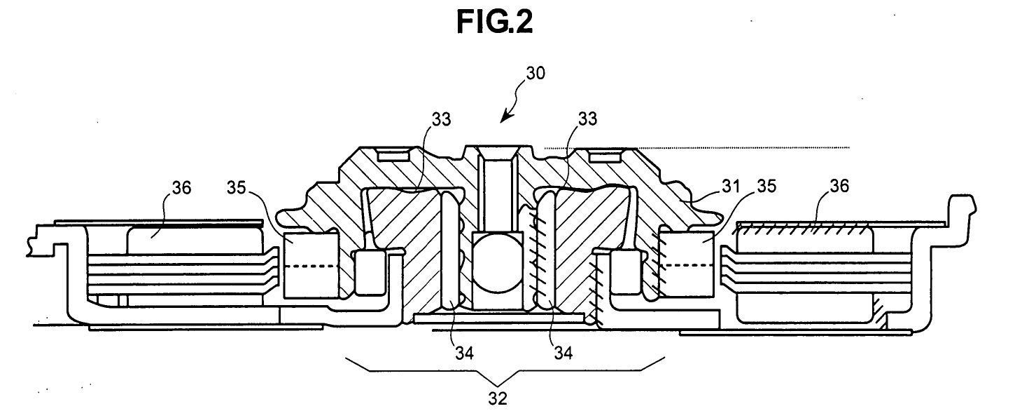

FIG. 1 shows a small magnetic disk drive 10 in a specific embodiment of the present invention. The magnetic disk drive 10 has outside dimensions of about 42.8 mm×36.4 mm×5 mm. The diameter of a magnetic disk 40, i.e., a storage medium, is about 1 in. (25.4 mm). A spindle motor 30 (FIG. 2) is fixed to the bottom wall of a metal base plate 20, i.e., a case formed in the shape of a box by press working. The spindle motor 30 is provided with a built-in fluid dynamic bearing (FDB) 32. A spindle hub 31 is supported on the FDB 32, and the magnetic disk 40 is mounted on the spindle hub 31 and is fastened to the spindle hub 31 with a top clamp 41.

A head arm 50 serving as a suspension assembly is attached to a carriage turning shaft 54 pivotally supported on the bottom wall of the base plate 20. A flexure 51 is connected to the head arm 50, and a load beam 52 is connected to the flexure 51. A gimbal is supported on the tip of the flexure 51. A magnetic head 53 including a slider is attached to the gimbals. The flexure 51 is provided with a spring between the joint of the flexure 51 and the head arm 50 and that of the flexure 51 and the load beam 52 to place load (gram load) on the magnetic head 53. A gram load produced by a resilient part of the flexure 51 is applied through the load beam 52 to the magnetic head 53 to press the magnetic head 53 toward the magnetic disk 40.

A voice coil motor (VCM) 55 fixed to the bottom wall of the base plate 20 drives the head arm 50 for turning. The magnetic head 53 is located at a position corresponding to a desired recording track for writing information to or reading information from the magnetic disk 40 or for writing information to and reading information from the magnetic disk 40 by turning the head arm 50 to move the magnetic head 53 held by the gimbals on the flexure 51 in a direction parallel to a radius of the magnetic disk 40. Signals provided by the magnetic head 53 is transmitted through a FC (flex cable) to an interface connector 60 connected to an external device to send the signals provided by the magnetic head 53 to the external device.

A frame bumper 70 formed of an elastic material surround the base plate 20. The frame bumper 70 serves as a shock-absorbing member. The frame bumper 70 is a molding provided with a side slot 80 required of the compact flash type 2. The small magnetic disk drive 10 can be protected from lateral shocks by covering the side surfaces (two dimensional outer side surfaces) by the frame bumper 70 and the interface connector 60.

FIG. 2 is a sectional view of the spindle motor 30. The spindle hub 31 supporting the magnetic disk 40 is supported by the fluid dynamic bearing (FDB) 32 including a thrust bearing 33 and a radial bearing 34. The spindle hub 31 is driven for turning by the agency of a permanent magnet 35 and an electromagnet 36. The spindle hub 31 floats relative to a sleeve.

The FDB 32 is used for supporting the spindle hub 31 of the spindle motor 30 and the spindle motor 30 operates at a low rotating speed to achieve the reduction of noise and power consumption. Desirably, the rotating speed of the spindle motor 30 is about 4200 rpm or below. In this embodiment, the rotating speed of the spindle motor 30 is about 3600 rpm. When the spindle motor 30 operates at a low rotating speed, the gram load placed on the magnetic disk 40 by the magnetic head 53 tilts the magnetic disk 40. Consequently, the spindle hub 31 of the spindle motor 30, and the stator come into contact with a specific local part of the thrust bearing 33, the bearing is damaged, and the spindle motor 30 becomes unable to operate normally.

In this embodiment, the gram load to be placed on the magnetic head 53 to press the magnetic head 53 toward the magnetic disk is about 0.5 gf or above and less than about 1.0 gf. Such a small load is produced by the spring of the flexure 51 connecting the head arm 50 and the load beam 52 of the suspension assembly. The flexure 51 is a thin metal sheet forming the gimbals. Such a small gram load of about 0.5 gf or above and less than about 1.0 gf can be produced by a resiliently flexible part of the flexure 51. The magnetic head 53 is vibrated by a slight external shock and strikes magnetic disk 40 if the gram load is excessively small. Therefore, the gram load is about 0.5 gf or above.

Preferably, the slider including the magnetic head 53 is a picoslider or a femtoslider. The picoslider measures about 1.25 mm in length, about 1 mm in width, and about 0.3 mm in thickness. The femtoslider measures about 0.85 mm in length, about 0.7 mm in width, and about 0.23 mm in thickness. The picoslider is preferable if importance is place on the stability of the floating characteristic of the magnetic head. The femtoslider is preferable if it is desired to expand the recording region of the magnetic disk.

In this embodiment, the magnetic disk is a 1 in. diameter disk. In view of applying the magnetic disk drive to portable devices, the magnetic disk may be such as having a diameter of about 1.8 in. (45.7 mm) or below. The size of the magnetic disk is dependent on a necessary storage capacity. A smaller magnetic disk can be used by increasing recording density.

In the specific embodiment of the present invention, the magnetic disk can stably be rotated even though the rotating speed of the spindle motor is low by employing the FDB in the spindle motor, using the magnetic disk having a small diameter, and placing the gram load of less than about 1.0 gf on the magnetic head. Thus, the small magnetic disk drive operates silently at low power consumption.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

1. A magnetic disk drive comprising:
a motor having a rotating shaft supported by a fluid dynamic bearing;
a magnetic disk mounted on the rotating shaft; and
a magnetic head pressed toward the magnetic disk by a loading force of about 0.5 gf or above and less than about 1.0 gf for data recording or reproducing, or for data recording and reproducing.

2. The magnetic disk drive according to claim 1, wherein an operating speed of the motor is about 4200 rpm or below, and a diameter of the magnetic disk is about 1 in. (25.4 mm) or below.

3. The magnetic disk drive according to claim 1, wherein the magnetic head includes a slider of about 1.25 mm in length, about 1 mm in width, and about 0.3 mm in thickness.

4. The magnetic disk drive according to claim 1, wherein the magnetic head includes a slider of about 0.85 mm in length, about 0.7 mm in width, and about 0.23 mm in thickness.

5. A magnetic disk drive comprising:
a case;
a motor fixed to the case and having a rotating shaft supported by a fluid dynamic bearing;
a magnetic disk mounted on the rotating shaft;
a carriage turning shaft pivotally supported on the case and attached to a suspension assembly; and
a magnetic head attached to the suspension assembly, and pressed toward the magnetic disk by a loading force of about 0.5 gf or above and less than about 1.0 gf.

6. The magnetic disk drive according to claim 5, wherein an operating speed of the motor is about 4200 rpm or below, and a diameter of the magnetic disk is about 1 in. (25.4 mm) or below.

7. The magnetic disk drive according to claim 1, wherein the magnetic head includes a slider of about 1.25 mm in length, about 1 mm in width, and about 0.3 mm in thickness.

8. The magnetic disk drive according to claim 5, wherein the magnetic head includes a slider of about 0.85 mm in length, about 0.7 mm in width, and about 0.23 mm in thickness.

9. A magnetic disk drive comprising:
a base plate;
a spindle motor fixed to the base plate, and provided with a spindle hub supported by a fluid dynamic bearing;
a magnetic disk mounted on the spindle hub; a carriage turning shaft pivotally supported on the base plate and attached to a suspension assembly; and
a slider attached to the suspension assembly, and pressed toward the magnetic disk by a loading force of about 0.5 gf or above and less than about 1.0 gf.

10. The magnetic disk drive according to claim 9, wherein an operating speed of the motor is about 4200 rpm or below, and a diameter of the magnetic disk is about 1 in. (25.4 mm) or below.

11. The magnetic disk drive according to claim 9, wherein the slider measures about 1.25 mm in length, about 1 mm in width, and about 0.3 mm in thickness.

12. The magnetic disk drive according to claim 9, wherein the slider measures about 0.85 mm in length, about 0.7 mm in width, and about 0.23 mm in thickness.

13. A magnetic disk drive comprises:
a base plate;
a spindle motor fixed to the base plate, and having a spindle hub supported by a fluid dynamic bearing;
a magnetic disk mounted on the spindle hub;
a carriage turning shaft pivotally supported on the base plate and attached to a suspension assembly;
a slider attached to the suspension assembly and pressed toward the magnetic disk by a loading force of about 0.5 gf or above and less than about 1.0 gf; and
a voice coil motor fixed to the base plate to drive the suspension assembly for turning.

14. The magnetic disk drive according to claim 13, wherein an operating speed of the motor is about 4200 rpm or below, and a diameter of the magnetic disk is about 1 in. (25.4 mm) or below.

15. The magnetic disk drive according to claim 13, wherein the slider measures about 1.25 mm in length, about 1 mm in width, and about 0.3 mm in thickness.

16. The magnetic disk drive according to claim 13, wherein the slider measures about 0.85 mm in length, about 0.7 mm in width, and about 0.23 mm in thickness.

17. A magnetic disk drive comprising: a base plate;
a spindle motor fixed to the base plate, and having a spindle hub supported by a fluid dynamic bearing including a radial bearing and a thrust bearing;
a magnetic disk mounted on the spindle hub;
a carriage turning shaft pivotally supported on the base plate, and attached to a suspension assembly; and
a magnetic head attached to the suspension assembly, and pressed toward the magnetic disk by a loading force of about 0.5 gf or above and less than about 1.0 gf.

18. The magnetic disk drive according to claim 17, wherein an operating speed of the motor is about 4200 rpm or below, and a diameter of the magnetic disk is about 1 in. (25.4 mm) or below.

19. The magnetic disk drive according to claim 17, wherein the slider measures about 1.25 mm in length, about 1 mm in width, and about 0.3 mm in thickness.

20. The magnetic disk drive according to claim 17, wherein the slider measures about 0.85 mm in length, about 0.7 mm in width, and about 0.23 mm in thickness
